(19) United States
(12) Patent Application Publication
(10) Pub. No.: US 2024/0181394 A1
(43) Pub. Date: Jun. 6, 2024

(54) SYSTEM AND METHOD FOR RECOVERING ORGANIC ACID PRODUCTS FROM A MULTICOMPONENT FEED SOLUTION

(71) Applicant: The Board of Trustees of the University of Illinois, Urbana, IL (US)

(72) Inventors: Xiao Su, Champaign, IL (US); Nayeong Kim, Champaign, IL (US); Jiho Lee, Champaign, IL (US)

(21) Appl. No.: 18/527,934

(22) Filed: Dec. 4, 2023

Related U.S. Application Data
(60) Provisional application No. 63/430,097, filed on Dec. 5, 2022.

(51) Int. Cl. B01D 61/46

(52) U.S. Cl. CPC B01D 61/461; B01D 61/463; B01D 2313/345; B01D 2313/365

(57) ABSTRACT

A system for recovering organic acid products from a multicomponent feed solution includes: a first electrode; a second electrode positioned in opposition to the first electrode; a cation exchange membrane and an anion exchange membrane disposed between the first and second electrodes, thereby defining a feed channel extending between the cation and anion exchange membranes for delivery of a multicomponent feed solution including an organic acid and an inorganic salt; a functionalized membrane disposed between the cation or anion exchange membrane and the first or second electrode, thereby defining an accumulating channel extending between the cation or anion exchange membrane and the functionalized membrane for collecting charged organic species separated from the multicomponent feed solution; and a redox channel containing the first and second electrodes and being separated from the feed and accumulating channels by the cation or anion exchange membrane and the functionalized membrane.

### RELATED APPLICATION

The present patent document claims the benefit of priority under 35 U.S.C. 119(e) to U.S. Provisional Patent Application 63/430,097, which was filed on Dec. 5, 2022, and is hereby incorporated by reference in its entirety.

### STATEMENT OF FEDERALLY FUNDED RESEARCH OR DEVELOPMENT

This invention was made with government support under T-PC01-A-12-0083 awarded by the U.S. Air Force. The government has certain rights in the invention.

### TECHNICAL FIELD

The present disclosure is related generally to electrodialysis and more particularly to separation of organic acids from multicomponent fluid streams by integration of a functionalized membrane with a redox-mediated electrodialysis system.

### BACKGROUND

Organic acids have become indispensable chemical compounds due to their multitude of uses in food, chemical synthesis, cosmetics, and pharmaceutical products. For example, succinic acid and its derivatives have experienced a rapid market expansion with an annual growth rate of 9.7% because of their increasing demand in traditional usages (e.g., food additives and detergents) and growing interest in biodegradable polymers and anticarcinogenic agents. On account of its sustainability and availability of feedstock (e.g. glucose), the majority of these organic acids are produced via the fermentation process. Recovering and purifying these organic acid products through downstream processing is one of the most challenging steps in the manufacturing train, due to the complexity of fermentation broth, which contains residual carbohydrates (e.g., glucose), inorganic salts (e.g., NaCl), and a multitude of by-products. Traditionally, the recovery of organic acid products from multicomponent mixtures requires a series of separation technologies such as filtration, liquid-liquid extraction, and ion exchange. These energy- and chemical-intensive separation processes can account for 50-70% of the overall organic acid production cost.

### BRIEF DESCRIPTION OF THE DRAWINGS

FIG. 1A is a schematic illustration of recovery of anionic organic species using an exemplary redox-mediated electrochemical system.

FIG. 1B is a schematic providing a mechanistic understanding of the selective organic acid recovery from inorganic species.

FIG. 1C shows one example of a process to synthesize an exemplary functionalized membrane.

FIG. 1D is a schematic illustration of recovery of cationic organic species using an exemplary redox-mediated electrochemical system.

FIG. 2A shows a liquid-atomic force microscopy (AFM) image of an anion-exchange membrane (AEM).

FIG. 2B shows an AFM image of a layer-by-layer functionalized membrane (LBL10).

FIG. 2C shows scanning electron microscopy (SEM) images of the AEM and LBL10 surfaces in dried conditions.

FIG. 2D shows energy-dispersive X-ray spectroscopy (EDS) spectra for the AEM and LBL10.

FIG. 2E shows a cross-sectional SEM image of the AEM.

FIG. 2F shows a cross-sectional SEM image of the LBL10.

FIGS. 2G-2J show x-ray photoelectron spectroscopy (XPS) spectra of surfaces of AEM and LBL10 membranes of O1s, N1s, C1s, and S2p, respectively.

FIG. 3A shows ionic flux of Cl⁻, NO₃⁻, HPO₄²⁻, SO₄²⁻, and succinate (Suc²⁻) and changes in monovalent, divalent, and succinate fluxes (inset) with respect to the number of layers.

FIG. 3B shows permeability ratio at varying polyelectrolyte layers (LBL3, LBL5, and LBL10) on an anion-exchange membrane (AEM), where the migration of ions across the membrane was tested in 10 mM of Cl⁻, NO₃⁻, HPO₄²⁻, SO₄²⁻, and Suc²⁻ under constant current operation of 10 mA.

FIG. 3C shows fourier-transform infrared spectroscopy (FTIR) data for the membranes having varying polyelectrolyte layers.

FIG. 3D shows membrane surface zeta potential for the different membranes.

FIG. 3E shows contact angle of the AEM, LBL3 (PSS₃/PEI₂), LBL5 (PSS₅/PEI₄), and LBL10 (PSS₁₀/PEI₉).

FIG. 3F shows Ionic resistances of 750 mM NaCl, 500 mM Na₂SO₄, and 500 mM Na₂Suc across the AEM and LBL10.

FIG. 4A shows organic acid flux and charge efficiency for different organic acid enrichment processes.

FIG. 4B shows the corresponding Cl⁻ depletion flux in the accumulating channel for the different organic acid enrichment processes.

FIG. 4C shows the corresponding change in Cl⁻ concentrations in the feed channel for the different organic acid enrichment processes.

FIG. 4D shows the corresponding change in Cl⁻ concentrations in the accumulating channel for the different organic acid enrichment processes.

FIG. 5A shows voltage curves at different current densities for conventional ED and redox-mediated ED systems to examine the salt removal performance with 25 mM NaCl as a target solution.

FIG. 5B shows conductivity and pH profiles at different current densities for conventional ED and redox-mediated ED systems to examine the salt removal performance with 25 mM NaCl as a target solution.

FIG. 5C shows accumulation of succinic acid and corresponding voltage curves over 1 hour of the succinic acid enrichment for the conventional ED and redox-mediated ED operations.

FIG. 5D shows energy consumption, and succinate flux over 1 hour of the succinic acid enrichment for the conventional ED and redox-mediated ED operations.

FIGS. 5E and 5F show, respectively, FTIR spectra and a mechanistic scheme of LBL membrane degradation from chlorine oxidation.

FIG. 6A shows redox-mediated succinic acid recovery from a synthetic fermentation downstream solution.

FIG. 6B shows concentration profiles of succinate, chloride, and glucose as a function of time

FIGS. 6C and 6D show, respectively, an SEM image and NMR spectrum of crystal succinic acid recovered from the synthetic fermentation solution.

### DETAILED DESCRIPTION

The design of molecularly-selective membranes is of paramount importance for the selective separation of organic acids from complex fermentation streams, due to the presence of multicomponent neutral and charged species. Described in this disclosure is a layer-by-layer polyelectrolyte functionalization approach for controlling ion-selectivity to achieve separation of organic acids in a redox-flow electrodialysis platform. The electrochemical system and method described herein integrate a functionalized membrane with a redox-mediated electrochemical system for selective separation of charged organic species from multicomponent mixture solutions. The system and method can utilize commercially-available ion exchange membranes for separation of charged ions from neutrals, while the finely-modulated functionalized membrane enables the separation of charged organic species from inorganic ions. By leveraging a reversible redox reaction at voltages below the water-splitting reaction, the system can lower energy consumption and also reduce the propensity for membrane degradation.

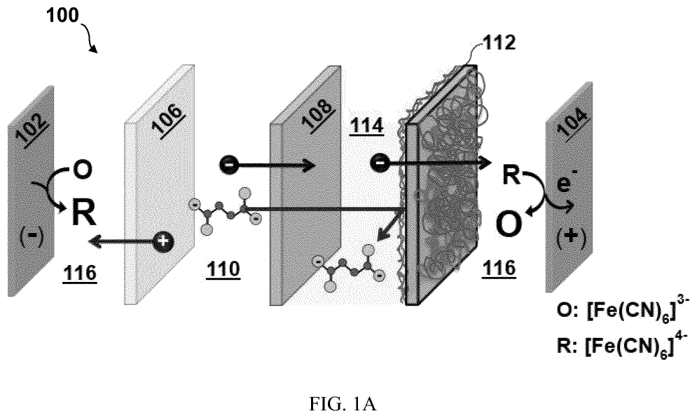

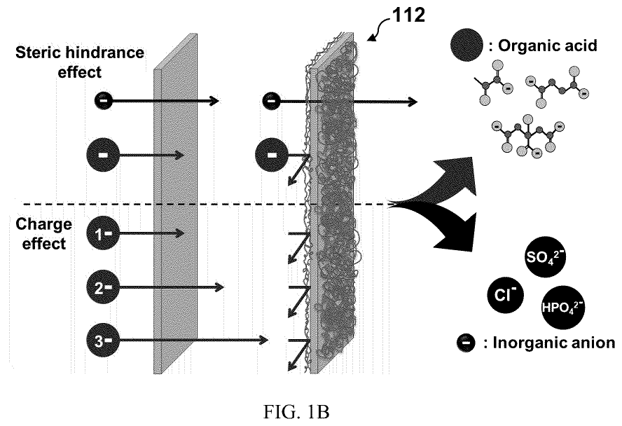

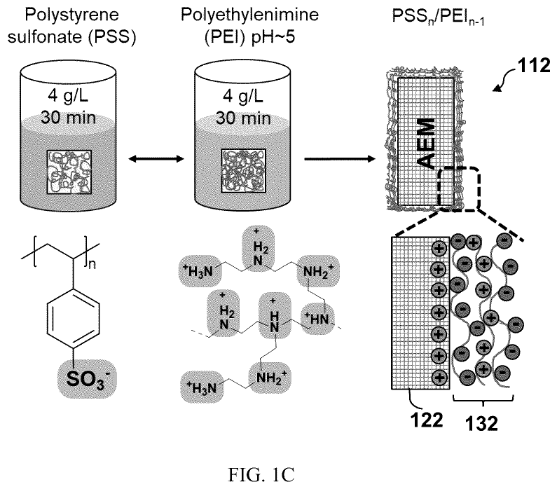

Referring to FIG. 1A, one example of the system 100 for redox-mediated electrodialysis includes a first electrode 102, a second electrode 104 positioned in opposition to the first electrode 102, and a cation exchange membrane 106 and an anion exchange 108 membrane positioned between the first electrode 102 and the second electrode 104. A feed channel 110 extends between the anion and cation exchange membranes 108,106 for delivery of a multicomponent feed solution (e.g., a fermentation stream) including an organic acid and an inorganic salt. The system further includes a functionalized membrane 112 disposed between the cation or anion exchange membrane 106,108 and the first or second electrode 102,104. (In the example of FIG. 1A, the functionalized membrane 112 is positioned between the anion exchange membrane 108 and the second electrode 104, as discussed further below.) An accumulating channel 114 extends between the cation or anion exchange membrane 106,108 and the functionalized membrane 112 for collecting charged organic species separated from the multicomponent feed solution. The system also includes a redox channel 116 that contains the first and second electrodes 102,104 and is configured for continuous circulation of a redox fluid or solution; that is, the redox channel 116 may form a closed loop. As discussed below, the redox solution may include a redox couple such as [Fe(CN)₆]⁴⁻/[Fe(CN)₆]³⁻, as shown in FIG. 1A, where “O” indicates the oxidized species and “R” indicates the reduced species of the redox couple. The redox channel 116 is separated from the feed channel 110 by the anion or cation exchange membrane 108,106 and the functionalized membrane 112. Flow through each of the channels (feed, accumulating and redox channels 110,114,116) may be independently controllable, e.g., by one or more pumps. The system may include a power supply connected to the first and second electrodes 102,104 for application of a suitable voltage (potential).

The functionalized membrane 112 includes, as illustrated in FIGS. 1B and 1C, a membrane backbone 122, and one or more polyelectrolyte layers 132 coated on the membrane backbone 122. Depending on the selection of the membrane backbone 122 and the one or more polyelectrolyte layers 132, the selectivity of the functionalized membrane 112 may vary between neutral and charged species, multivalent and monovalent species, and/or organic and inorganic species. The membrane backbone may comprise an anion exchange membrane as shown in FIG. 1C (e.g., a polymer film including positively-charged functional groups), a cation exchange membrane (e.g., a polymer film including negatively-charged functional groups), a nanofiltration membrane, or a cellulose-based membrane. In examples where the membrane backbone comprises an ion (anion or cation) exchange membrane, the ion exchange membrane may be referred to in this disclosure as an anion exchange membrane backbone or a cation exchange membrane backbone, in order to avoid confusion with the anion and cation exchange membranes that define the feed channel, as described above.

The functionalized membrane may be designed to achieve perm-selectivity among the same charged species based on the ionic valence, hydrophilicity, and/or molecular size of the target species, allowing for separation of organic acids from inorganic anions, as illustrated in FIG. 1B. For example, the combination of the polyelectrolyte layers and redox-mediated electrodialysis enables succinic acid recovery from multicomponent solutions (e.g., mixtures of Cl⁻, NO₃⁻, HPO₄²⁻, SO₄²⁻, and succinate). In examples described below, the system is further demonstrated for a wider range of organic acid separations, including pyruvate, succinate, and citrate, regardless of their valence charges (mono- to multivalent) and even partitioning of the complex mixture in a single stage, possibly valorizing residual carbohydrates and inorganic salts in tandem with the organic acid products.

The system may be configured for separation of anionic or cationic organic species. The exemplary system 100 show in FIG. 1A is configured for separation of anionic organic species from multicomponent waste streams. Anionic organic species may be derived from organic acids such as succinic, pyruvic and/or citric acid.

Referring again to FIG. 1A, the functionalized membrane 112 may be positioned between the anion exchange membrane 108 and the second electrode 104, and thus the accumulating channel 114 may extend between the anion exchange membrane 108 and the functionalized membrane 112. Also, the redox channel 116 may be separated from the feed and the accumulating channels 110,114 by the cation exchange membrane 106 and the functionalized membrane 112. The second electrode 104 may be configured to become positively charged upon application of a voltage in this example. The accumulating channel 114 may be configured to collect the anionic organic species separated from the multicomponent feed solution.

The functionalized membrane 112 may include only one (a single) polyelectrolyte layer 132 on the membrane backbone. In such an example, the single polyelectrolyte layer 132 may be a polyanion layer. Alternatively, the one or more polyelectrolyte layers 132 may include a number of the polyanion layers and polycation layers. Preferably, the polyanion and polycation layers have an alternating arrangement, where an outermost layer of the one or more polyelectrolyte layers 132 may be one of the polyanion layers, as illustrated in FIG. 1C. Generally speaking, the one or more polyelectrolyte layers 132 may include n of the polyanion layers and n−1 of the polycation layers, where n is an integer from 2 to 20. As discussed in the examples below, deposition of alternating polyanion/polycation layers may influence or control permeation of ionic species across the functionalized membranes. In particular, ion permeability results show that changes to the number of polyanion/polycation layers can influence (e.g., increase) selective enrichment of the anionic organic species in the accumulating channel while enhancing depletion of inorganic anions, especially monovalent anions. For example, n may be selected to be at least 3, at least 5, or at least 10. The polyanion layers may comprise a polyanion selected from the group consisting of polystyrenesulfonate (PSS), poly vinyl sulfonate (PVS), sulfonated poly (ether ether ketone) (SPEEK), and polyacrylic acid (PAA). The polycation layers may comprise a polycation selected from the group consisting of polyethylenimine (PEI), poly(allylamine hydrochloride) (PAH), poly(diallyldimethyl-ammonium chloride) (PDDA), poly(diallyldimethylammonium chloride) (PDADMAC), and polyaniline (PANI). The membrane backbone 122 may comprise an anion exchange membrane backbone.

Alternatively, the system 100 may be configured for separation of cationic organic species from multicomponent waste streams, as shown for example in FIG. 1D. Cationic organic species may be derived from organic acids such as amino acid.

Referring to FIG. 1D, the functionalized membrane 112 may be positioned between the cation exchange membrane 106 and the second electrode 104, and thus the accumulating channel 114 may extend between the cation exchange membrane 106 and the functionalized membrane 112. Also, the redox channel 116 may be separated from the feed and the accumulating channels 110,114 by the anion exchange membrane 108 and the functionalized membrane 112. The second electrode 104 may be configured to become negatively charged upon application of a voltage in this example. The accumulating channel 114 may be configured to collect the cationic organic species separated from the multicomponent feed solution.

The functionalized membrane 112 may include only one (a single) polyelectrolyte layer 132 on the membrane backbone 122. In this example, the single polyelectrolyte layer 132 may be a polycation layer. Alternatively, the one or more polyelectrolyte layers 132 may include a number of the polycation layers and polyanion layers. Preferably, the polycation and polyanion layers have an alternating arrangement, where an outermost layer of the one or more polyelectrolyte layers 132 may be one of the polycation layers. Generally speaking, the one or more polyelectrolyte layers 132 may include n of the polycation layers and n−1 of the polyanion layers, where n is an integer from 2 to 20. As indicated above, deposition of alternating polycation/polyanion layers may influence or control permeation of ionic species across the functionalized membranes. In particular, proper selection of the number of polycation/polyanion layers may enable selective enrichment of the cationic organic species in the accumulating channel along with an efficient depletion of inorganic cations, especially monovalent cations. For example, n may be selected to be at least 3, at least 5, or at least 10. The polycation layers employed for the functionalized membrane may comprise a polycation selected from the group consisting of polyethylenimine (PEI), poly(allylamine hydrochloride) (PAH), poly(diallyldimethyl-ammonium chloride) (PDDA), poly(diallyldimethylammonium chloride) (PDADMAC), and polyaniline (PANI). The polyanion layers may comprise a polyanion selected from the group consisting of polystyrenesulfonate (PSS), poly vinyl sulfonate (PVS), sulfonated poly (ether ether ketone) (SPEEK), and polyacrylic acid (PAA). The membrane backbone may comprise a cation exchange membrane backbone.

In some systems, the cation exchange membrane, the anion exchange membrane, and the functionalized membrane may define a first set of membranes, and the system may further include, between the first and second electrodes, one or more additional sets of membranes. Also or alternatively, the first electrode may be part of a stack of first electrodes, and/or the second electrode may be part of a stack of second electrodes.

A method for selective separation of organic acids from a multicomponent fluid stream or feed solution has also been developed. First, separation of anionic organic species derived from organic acids such as succinic, pyruvic and/or citric acid is described, and then separation of cationic organic species derived from organic acids such as amino acid is described.

In the first example, the method includes providing the system described above in reference to FIG. 1A, where the functionalized membrane 112 is disposed between the anion exchange membrane 108 and the second electrode 104, such that the accumulating channel 114 extends between the anion exchange membrane 108 and the functionalized membrane 112, and where the redox channel 116 is separated from the feed and the accumulating channels 110,114 by the cation exchange membrane 106 and the functionalized membrane 112, respectively. The method includes flowing a redox solution comprising a redox couple (e.g., [Fe(CN)₆]⁴⁻/[Fe(CN)₆]³⁻) through the redox channel 116, and flowing a multicomponent feed solution including an organic acid and inorganic salt through the feed channel 110, where the organic acid and the inorganic salt comprise ionic species. It is understood that the multicomponent feed solution may include more than one organic acid and/or more than one inorganic salt.

A voltage (potential) is applied and the first electrode 102 becomes negatively charged and the second electrode 104 becomes positively charged, such that the redox couple undergoes reduction near the first electrode 102 and oxidation near the second electrode 104. As a result, anionic species from the multicomponent feed solution are drawn through the anion exchange membrane 108 into the accumulating channel 114, cationic species are drawn through the cation exchange membrane 106, and neutral species remain in the feed channel 110. The anionic species may include anionic organic species and anionic inorganic species. The redox couple circulates through the redox channel 116, alternately undergoing reduction near the first electrode 102 and oxidation near the second electrode 104, allowing for continuous removal of the ionic species from the feed channel 110. After being drawn through the anion exchange membrane 108, the anionic organic and inorganic species are separated; more specifically, the anionic inorganic species are drawn through the functionalized membrane 112 and the anionic organic species remain and accumulate in the accumulating channel 114.

The anionic organic species may be enriched in the accumulating channel 114 at a flux rate of at least about 0.05 mol/m²/h and/or up to about 0.07 mol/m²/h at an operating current of 10 mA, which may correspond to a current density of about 1 mA/cm². Under the same conditions, the anionic inorganic species may be depleted from the accumulating channel at a flux rate at or below −0.06 mol/m²/h and/or down to about −0.13 mol/m²/h, as shown in the examples below. The enrichment and depletion may occur continuously while the voltage is applied, which may be for a time duration of at least 1 hour and/or as long as 40 hours, or more. Accordingly, organic acid products may be separated from the multicomponent feed solution and recovered. If desired, the enriched and recovered anionic organic species may undergo a subsequent crystallization process to produce purified organic acid crystals.

The anionic inorganic species drawn through the functionalized membrane 112 and out of the accumulating channel 114 enter the redox channel 116. In the redox channel 116, the anionic inorganic species may recombine with the cationic inorganic species which enter the redox channel 116 through the cation exchange membrane 106. Consequently, the inorganic salt(s) from the multicomponent feed solution may also be collected and recovered. Similarly, any neutral species remaining in the feed channel 110 may be collected and recovered.

The multicomponent feed solution may comprise a fermentation solution from food, pharmaceutical, chemical, or industrial manufacturing. The system may be operated at a current below 30 mA. The voltage applied may be less than that required for water-splitting reaction, and thus the system 100 may be operated at less than 1.2 V, e.g., for a single-stack system with one feed channel 110 and one accumulating channel 114. The channels may have any desired size and shape, with longer channels being preferred. The organic acid may include succinic acid, pyruvic acid, lactic acid, and/or citric acid, and the corresponding anionic organic species may include succinate, pyruvate, lactate, and/or citrate. In some examples, the organic acid has a molecular weight of less than 200 g/mol. The inorganic salt may comprise an alkali salt and/or alkaline earth salt. Examples of the anionic inorganic species include Cl⁻, NO₃⁻, HPO₄²⁻, and/or SO₄²⁻, and examples of the cationic inorganic species include Li⁺, Na⁺, K⁺, Mg²⁺, and/or Ca²⁺. The neutral species may include proteins, peptides, and/or carbohydrates. The redox couple comprises a reversible redox species which may be selected from the following: V²⁺/V³⁺, VO²⁻/VO₂⁺, Zn/Zn²⁺, Fe²⁺/Fe³⁺, [Fe(CN)₆]⁴⁻/[Fe(CN)₆]³⁻, a quinone derivative, a 2,2,6,6-tetramethylpiperidine-1-oxyl (TEMPO) derivative, a ferrocene derivative, [Fe(bpy)₃]²⁺/[Fe(bpy)₃]³⁺, CoCp₂/CoCp₂⁺, ferrocene/ferrocenium, and/or V(acac)₃/[V(acac)₃]⁺.

FIG. 1D illustrates a second example directed to separation of cationic organic species. In this example, the method may include providing the above-described system 100, where the functionalized membrane 112 is disposed between the cation exchange membrane 106 and the second electrode 104, such that the accumulating channel 114 extends between the cation exchange membrane 106 and the functionalized membrane 112, and where the redox channel 116 is separated from the feed and the accumulating channels 110,114 by the anion exchange membrane 108 and the functionalized membrane 112, respectively. The method includes flowing a redox solution comprising a redox couple through the redox channel 116, and flowing a multicomponent feed solution including an organic acid and inorganic salt through the feed channel 110, where the organic acid and the inorganic salt comprise ionic species. It is understood that the multicomponent feed solution may include more than one organic acid and/or more than one inorganic salt.

A voltage (potential) is applied and the first electrode 102 becomes positively charged and the second electrode 104 becomes negatively charged, such that the redox couple undergoes oxidation near the first electrode 102 and reduction near the second electrode 104. As a result, cationic species from the multicomponent feed solution are drawn through the cation exchange membrane 106 into the accumulating channel 114, anionic species are drawn through the anion exchange membrane 108, and neutral species remain in the feed channel 110. The cationic species may include cationic organic species and cationic inorganic species. The redox couple circulates through the redox channel 116, alternately undergoing oxidation near the first electrode 102 and reduction near the second electrode 104, allowing for continuous removal of the ionic species from the feed channel 110. After being drawn through the cation exchange membrane 106, the cationic organic and inorganic species are separated. More specifically, the cationic inorganic species are drawn through the functionalized membrane 112 and the cationic organic species remain in the accumulating channel 114.

The cationic organic species may be enriched in the accumulating channel 114 and the cationic inorganic species may be depleted from the accumulating channel 114 at flux rates similar to those observed for the anionic organic species, as described above. The flux rates may depend on the operating current and voltage as well as on the size and charges of the organic species. The enrichment and depletion may occur continuously while the voltage is applied, which may be for a time duration of at least 1 hour and/or as long as 40 hours, or more. Accordingly, organic acid products may be separated from the multicomponent feed solution and recovered. If desired, the enriched and recovered cationic organic species may undergo a subsequent crystallization process to produce purified organic acid crystals.

The cationic inorganic species drawn through the functionalized membrane 112 and out of the accumulating channel 114 enter the redox channel 116. In the redox channel 116, the cationic inorganic species may recombine with the anionic inorganic species which enter the redox channel 116 through the anion exchange membrane 108. Consequently, the inorganic salt(s) from the multicomponent feed solution may also be collected and recovered. Similarly, any neutral species remaining in the feed channel 110 may be collected and recovered.

The multicomponent feed solution may comprise a fermentation solution from food, pharmaceutical, chemical, or industrial manufacturing. The system 100 may be operated at a current below 30 mA. The voltage applied may be less than that required for water-splitting reaction, and thus the system may be operated at less than 1.2 V, e.g., for a single-stack system with one feed channel 110 and accumulating channel 114. The channels may have any desired size and shape, with longer channels being preferred. The organic acid may include amino acid, and the cationic organic species may include tryptophan methyl ester, arginine methyl ester, and/or histidine methyl ester. In some examples, the organic acid may have a molecular weight of less than 200 g/mol. The inorganic salt may comprise an alkali metal salt and/or alkaline earth salt. Examples of the anionic inorganic species include Cl⁻, HPO₄²⁻, and/or SO₄²⁻, and examples of the cationic inorganic species include Li⁺, Na⁺, K⁺, Mg²⁺, and/or Ca²⁺. The neutral species may include proteins, peptides, and/or carbohydrates. The redox couple comprises a reversible redox species which may be selected from the following: V²⁺/V³⁺, VO²⁻/VO₂⁺, Zn/Zn²⁺, Fe²⁺/Fe³⁺, [Fe(CN)₆]⁴⁻/[Fe(CN)₆]³⁻, a quinone derivative, a 2,2,6,6-tetramethylpiperidine-1-oxyl (TEMPO) derivative, a ferrocene derivative, [Fe(bpy)₃]²⁺/[Fe(bpy)₃]³⁺, CoCp₂/CoCp₂⁺, ferrocene/ferrocenium, and/or V(acac)₃/[V(acac)₃]⁺.

### Examples

### Fabrication and Characterization of Functionalized Membrane

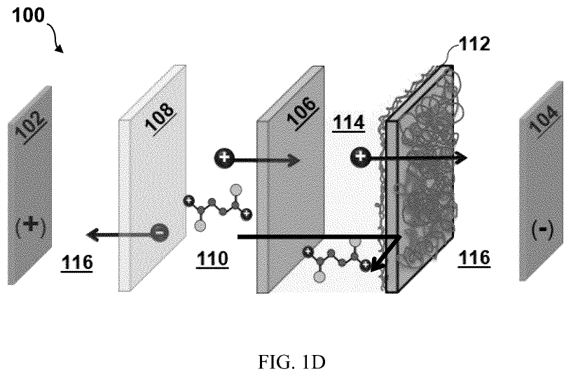

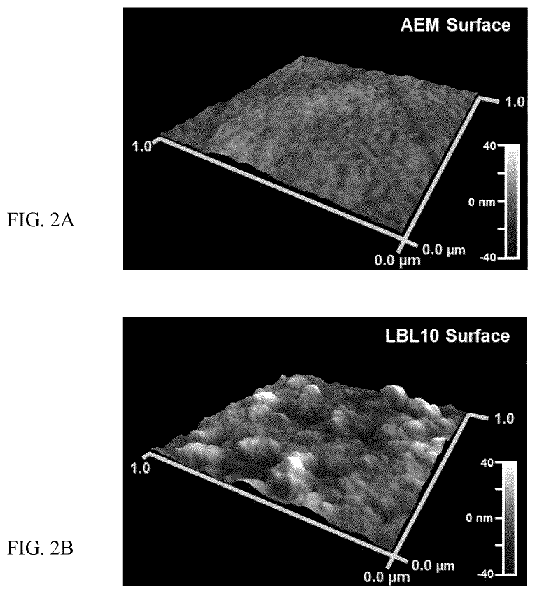

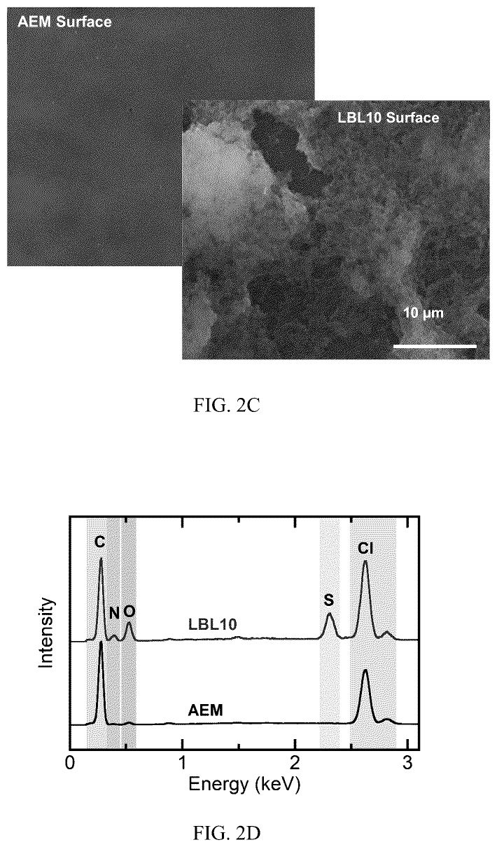

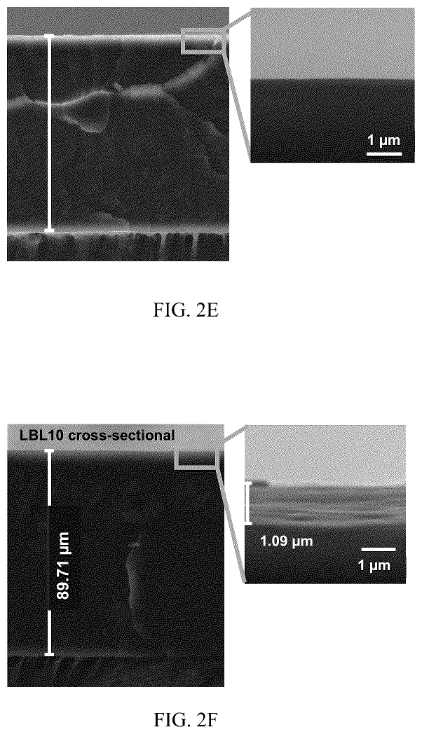

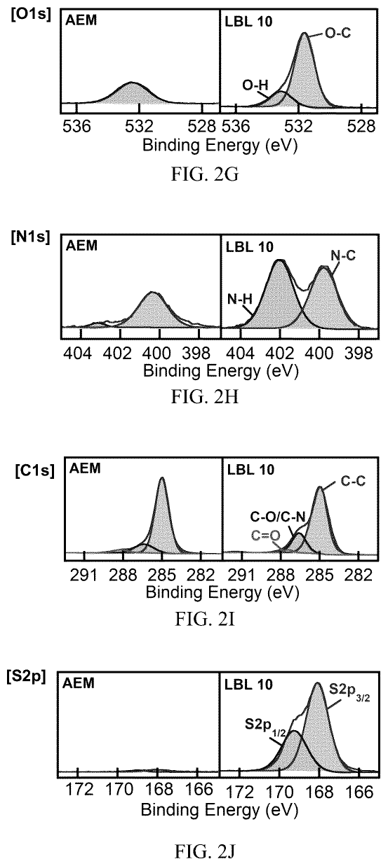

To achieve the requisite ion-selectivity towards the desired organic anions, the membrane was functionalized with layers of polyelectrolyte due to its facile synthesis and robust tunability of membrane surface morphology and properties. Polyelectrolyte deposition was conducted by alternating adsorption of negatively charged (PSS in this example) and positively charged (PEI in this example) polyelectrolytes onto a pristine anion exchange membrane (AEM). The term “pristine AEM” means that the AEM includes no polyelectrolyte layers. In this study, functionalized membranes were labeled according to the number of PSS layers, for instance, the functionalized membrane with an alternation of 10 PSS and 9 PEI layers (PSS₁₀/PEI₉) was denoted as LBL10, where LBL represents layer-by-layer. Liquid-phase atomic force microscopy (AFM) visualized the topography of distinct morphology and roughness of hydrated membrane surface between pristine AEM and LBL10, as shown in FIGS. 2A and 2B. The pristine AEM surface had a relatively low roughness of 5.49 nm with minor crumples, reflecting the structure of a highly cross-linked and uniformly polished polymeric surface. Meanwhile, the LBL10 had the surface roughness increased up to 21.29 nm with the formation of nanoscale heterogeneous papillae that are surrounded by narrow ridges, indicating the development of complex polyelectrolyte layers of PSS and PEI. In line with the liquid-AFM images, scanning electron microscopy (SEM) images for the dried-membrane surface showed a clear indication of dense polyelectrolyte layer formation on the smooth and flat surface of AEM. Moreover, cross-sectional SEM images highlighted ordered layers of polyelectrolyte depositions on LBL10 with a thickness of 1.09 μm (FIGS. 2E and 2F). In addition, a serial block face (SBF) SEM image showed the three-dimensional image of a cross-sectional LBL10 membrane, where highly dense polyelectrolyte layers were uniformly deposited at the surface of rough-textured pristine AEM.

Energy-dispersive x-ray spectroscopy (EDS) and x-ray photoelectron spectroscopy (XPS) characterization showed the development of distinctive peaks of ammonium and sulfonic groups, which are an indicator of PEI polycation and PSS polyanion deposition, respectively. The EDS spectra of pristine AEM were mostly composed of carbon with minor peaks of other elements, whereas prominent peaks of nitrogen, oxygen, and sulfur elements were visible in LBL 10, as shown in FIG. 2D. In C1s, and N1s spectra, new peaks of N—H and C—N bonds were found at 402 and 287 eV, respectively, reflecting the presence of tertiary ammonium groups ascribed to PEI coating on the AEM surface (FIGS. 2G and 2H). In addition, O1s and S2p spectra showed a peak at 532 eV and two S2p_{1/2} and S2p_{3/2} peaks at a lower binding energy of 171-166 eV that are assignable to R—SO₃⁻ functional groups of PSS layers (FIGS. 2I and 2J). Collectively, the morphological characterization of LBL10 confirms the successive formation of PSS/PEI multilayers on the AEM.

### Investigation of Membrane Permeability and Ion-Selectivity

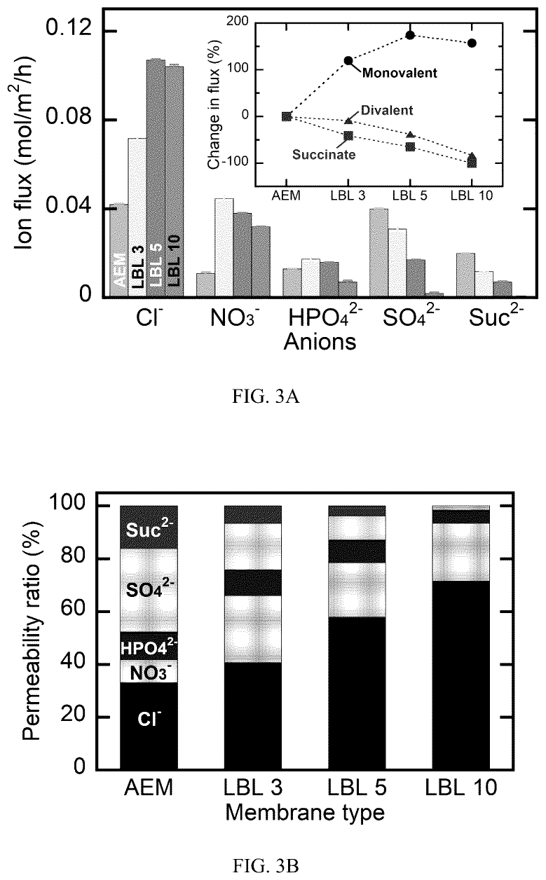

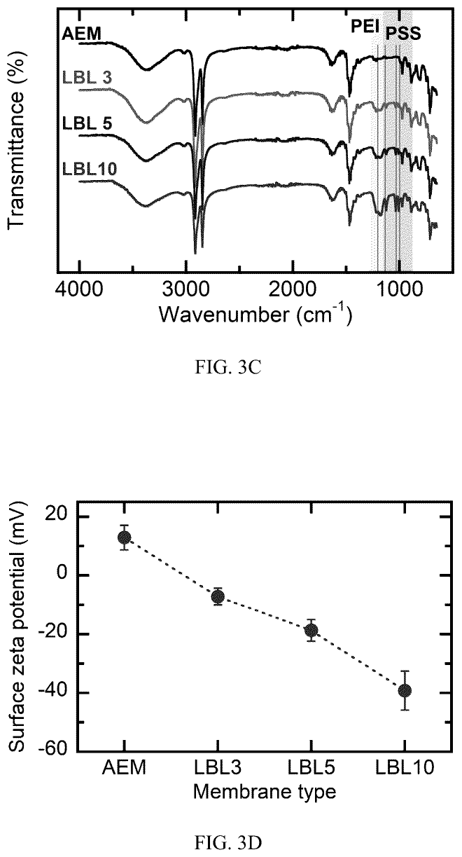

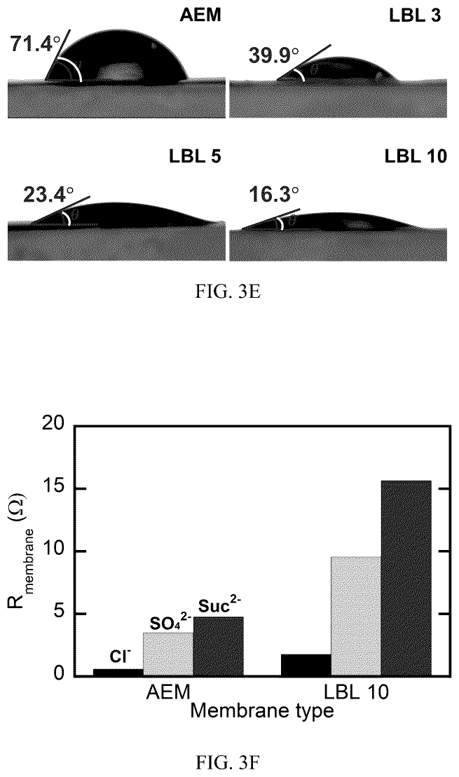

To evaluate ionic transport through the functionalized membranes, ion permeability was evaluated with a mixture of two monovalent, two divalent anions, and succinate (i.e., Cl⁻, NO₃⁻, HPO₄²⁻, SO₄²⁻, and succinate (Suc²⁻)) each at 10 mM concentration in a custom-made testing module. FIGS. 3A and 3B show the ionic flux of various anions and their permeability ratios with respect to the number of PSS/PEI layers on the AEM. Without PSS/PEI layers (AEM), the ionic fluxes were 0.042, 0.011, 0.013, 0.040, and 0.020 mol/m²/h for Cl⁻, NO₃⁻, HPO₄²⁻, SO₄²⁻, and Suc²⁻, respectively. These values equated to approximately 41.7%, 42.2%, and 16.1% permeability ratios among mono-, divalent anions, and succinate, respectively. The ionic flux across the pristine AEM was highly dependent on the valence charge of the species, as a larger portion of multivalent anions (58.3%) migrated across the AEM compared to monovalent anions (41.7%). This transport tendency was attributed to the presence of greater electrostatic attraction upon multivalent ions over monovalent ions. As shown in the inset of FIG. 3A, precise deposition of PSS/PEI polyelectrolyte layers modulated selective permeation of ionic species across the functionalized membranes. In comparison to the case of pristine AEM, the monovalent anionic flux increased by 174% with five polyelectrolyte layers (LBL5), but a 65% decrease in succinate flux (see inset of FIG. 3A). Further deposition of polyelectrolyte to LBL10 led to complete succinate retention, while 97% of the total anion permeability was still maintained. In particular, the monovalent anions preferably moved across the LBL10, attributing to 93.4% of the total permeability ratio, because the outermost layer of the functionalized membrane exerted a strong repulsive force on the divalent anions (FIG. 3B). The ion permeability results indicate that membrane tuning (e.g., number of polyanion/polycation layers) enables selective enrichment of the succinate in tandem with an efficient depletion of anions, especially monovalent anions.

The functionalized polyelectrolyte layers may also affect the membrane surface properties such as surface charges, hydrophilicity, and steric hindrance, which may result in an alteration of the molecule-membrane interactions. The Fourier-transform infrared spectroscopy (FTIR) spectra and XPS atomic composition of N and S supported the increase of functional charges from the deposition of PSS (1008-1175 cm⁻¹ for bond stretching of sulfonic groups and —C—H aromatic groups) and PEI (1630 and 1457 cm⁻¹ for amide and C—H bending) (FIG. 3C). As the number of PSS/PEI layers increased (FIG. 3D), the positive surface zeta potential of AEM (17 mV) became negative down to −40 mV for LBL10. The negative surface charge of the LBL10 caused a Donnan exclusion effect and exerted a strong electrostatic repulsive force against multivalent anionic species, reducing their migration across the functionalized membrane (FIGS. 3B and 3D). This result is congruent with previous studies elucidating that membrane selectivity can be controlled by the fixed electric charge at the membrane interface. On top of the membrane surface charge, steric hindrance and hydrophilicity further contributed to molecule-membrane interactions, allowing organic acid separations from multivalent ions. Among the divalent anionic species, permeability was in the order of HPO₄²⁻>SO₄²⁻>succinate. This notable rejection of succinate can be attributed to the larger molecular size of succinate compared to the competing inorganic species and weak molecule-membrane interactions between organic acids and hydrophilic membrane surfaces.^{]} The respective increase in Ohmic membrane resistance supports the steric hindrance effect with respect to the PSS/PEI polyelectrolyte layers. Besides, since the terminating layer of the functionalized membrane was hydrophilic PSS, the contact angle of AEM changed from 71.4° to 16.3° with the number of polyelectrolyte layers, resulting in the weak interaction of relatively hydrophobic organic acids and hydrophilic membrane surface (FIG. 3E).

Collectively, the membrane resistance shown in FIG. 3F reflects the ease of ion permeation (e.g., Cl⁻, SO₄²⁻, succinate) through the pristine and functionalized membranes. The membrane resistance of succinate increased from 4.75Ω to 15.6Ω because the highly dense polyelectrolyte layers resulted in a steric hindrance and increased the mass transfer resistance. The substantially high R_{membrane} of succinate compared to Cl⁻ and SO₄²⁻ provides a strong indication that LBL10 can be used as an efficient barrier for controlling the selective discrimination of succinate. On the other hand, the difference in membrane resistance for Cl⁻ in pristine AEM and LBL10 was the lowest among the three anions with their respective values of 0.597Ω and 1.756Ω, indicating the facile permeation of monovalent inorganic anion across the pristine AEM and LBL10 membranes.

### Selective Enrichment of Various Organic Acids

Based on the ionic flux results and membrane studies, the most effective membrane arrangement is selected as the pristine AEM (or just “AEM”) and functionalized membrane LBL10 in series, to achieve the greatest organic acid enrichment from the multicomponent mixture solution in tandem with the depletion of charged inorganic species, as illustrated in FIG. 1A. The AEM 108 is arranged between the feed channel (FC) 110 and organic acid accumulating channel (AC) 114 to separate both charged organic and inorganic anions from neutral species. Then, among the migrated anions in the AC 114, the organic acid was retained in the AC 114, while charged inorganic anions crossed over the functionalized membrane 112.

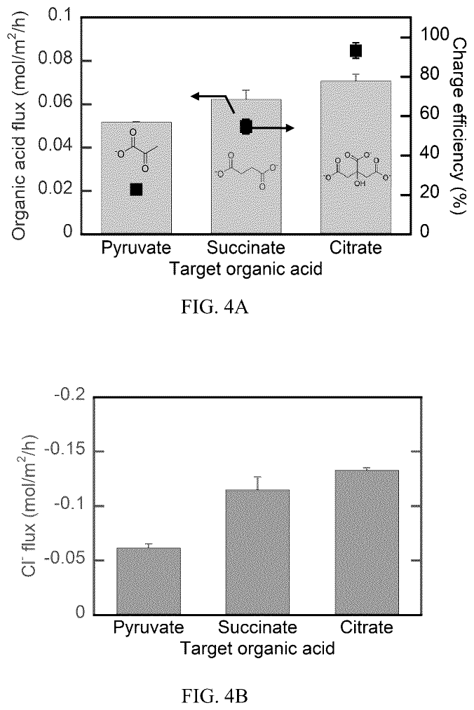

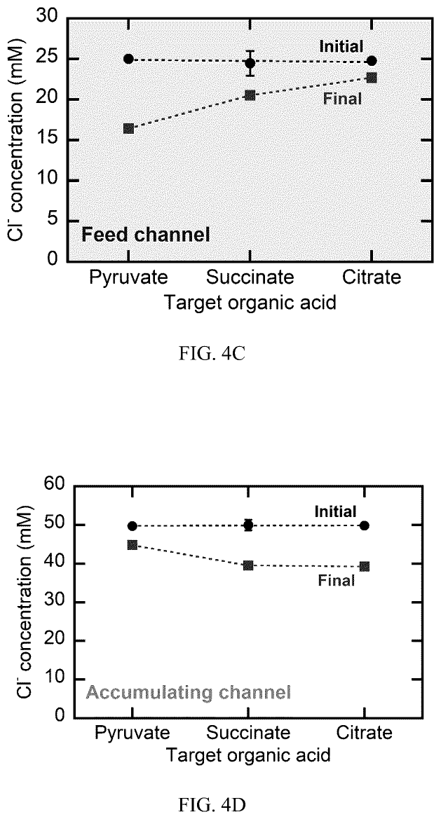

The proposed membrane-integrated system selectively enriched organic acids, regardless of their charges, from inorganic ions—even achieving selective recovery between monovalent organic acid and anion. Each representative fermentation organic acid with different charges (pyruvate (mono-), succinate (di-), and citrate (trivalent)), was tested against chloride, to investigate the feasibility of the functionalized membrane for precision separation against inorganic species. Notably, as the charge of the organic acid increased, both organic acid enrichment and inorganic acid depletion were enhanced. For instance, the organic acid fluxes increased by 37% from pyruvate (0.052 mol/m²/h) to citrate (0.071 mol/m²/h) (FIG. 4A). On the other hand, the values of chloride flux were negative, indicating the depletion of the inorganic salt from the accumulating channel. Besides, with a higher charge of target organic acid, the chloride flux became more negative from −0.067 mol/m²/h to −0.13 mol/m²/h (FIG. 4B). The organic acids with higher valences experience stronger Donnan exclusion on the negatively charged surface of the functionalized membrane, while they have a higher affinity towards the quaternary ammonium group on the surface of AEM, resulting in higher mobility. As a result, the up-concentration of citrate was 30% greater than that of pyruvate in tandem with 2-fold faster selective removal of inorganic anions.

Remarkably, the system was able to enrich pyruvate from chloride, discriminating between monovalent organic acid (pyruvate) and inorganic ion (chloride) (FIGS. 4A and 4B). Between the same charged species, the size and hydrophilicity of the species determine the ionic flux across the functionalized membrane. The dense polyelectrolyte layers on the functionalized membrane provide a steric hindrance effect and impede the diffusion of relatively large species, resulting in 7-fold greater ionic resistance (R_{LBL10}=12.3Ω) for pyruvate than chloride (R_{LBL10}=1.76Ω). Moreover, the membrane resistance for pyruvate was 30% greater than the SO₄²⁻ (divalent anions R_{LBL10}=9.54Ω), highlighting that the steric hindrance and hydrophilic interactions play more important roles in determining the mobility of charged species than the charge interaction. Therefore, between pyruvate and chloride, chloride tended to cross over the functionalized membrane more favorably (97% of ion permeation across the LBL10) due to chloride being the smaller and more hydrophilic ion. In this regard, only 2.5% of total pyruvate crossed over the functionalized membrane, while succinate and citrate were able to sustain in the accumulating channel without any noticeable crossover.

Moreover, as the charge of the deprotonated organic acid increased, the system revealed exceptional organic acid enrichment with an enhanced charge efficiency from 23% to 93% (FIG. 4A). Such high organic acid recovery attributes to the intrinsic membrane selectivity and the membrane arrangement in the system. The AEM positioned between the FC and AC favorably permeated divalent and trivalent organic acids, while LBL10 arranged between the LBL10 and RC only permeated anions (Cl⁻). Based on the flux results and charge efficiencies, the mobility of charged species within the AEM is mainly driven by the valence of species. However, for the functionalized membrane, the multivalent species experience strong electrostatic repulsion since the outer-most membrane surface became more negative (FIG. 3D). In terms of chloride mobility, as the charge of the competing organic acid increased, the chloride concentration merely changed in the feed channel but dropped in the accumulating channel (FIGS. 4C and 4D). The combination of the anion-exchange membrane and the functionalized resulted in not only the efficient enrichment of multivalent organic acids but also the depletion of the inorganic anions in the accumulating channel.

### Enhanced Organic Acid Recovery and Functional Membrane Stability

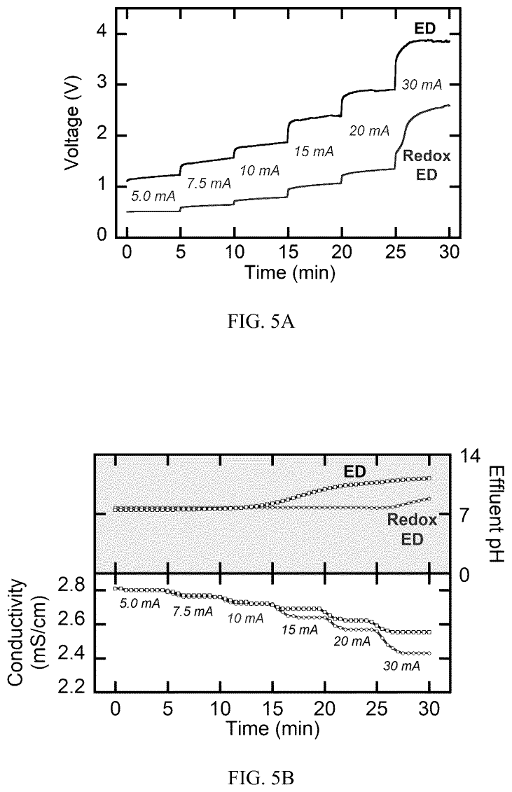

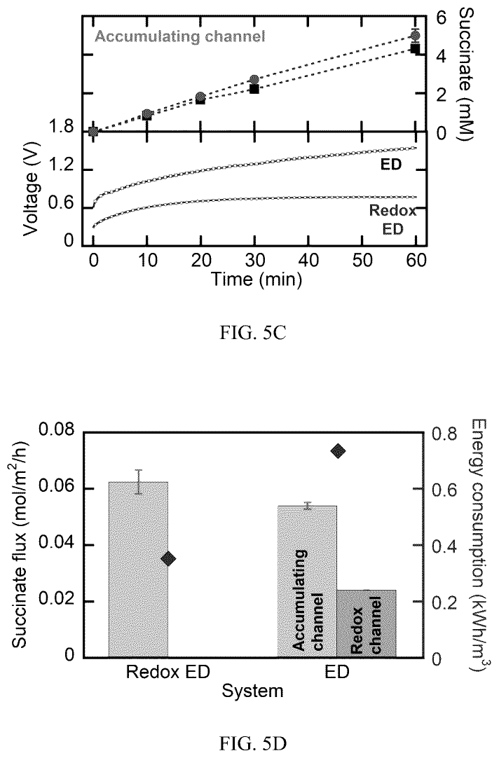

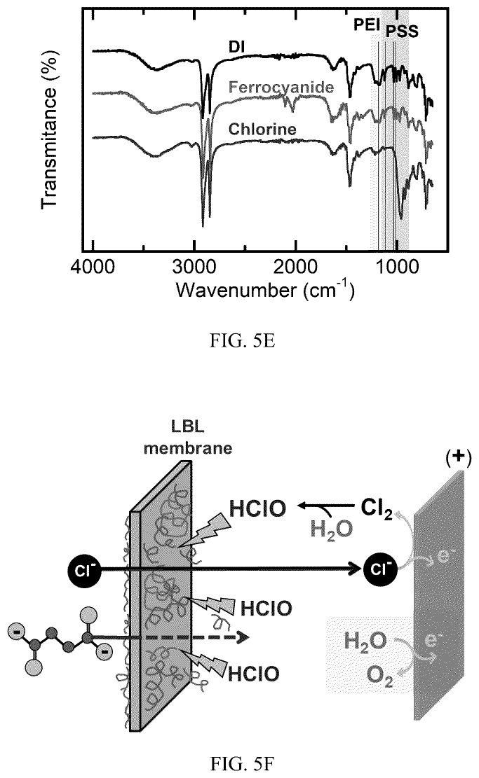

The redox-electrodialysis (ED) system revealed energy-efficient and robust succinate recovery compared to a conventional ED system. The desalination capability of the redox ED system was evaluated at different operating currents ranging from 0.56 mA/cm² (5.0 mA) to 3.3 mA/cm² (30 mA) and compared with the conventional ED system. Within the investigated current range, the redox ED system exhibited lower voltage profiles than the conventional ED system, resulting in a 40-60% reduced energy consumption (FIG. 5A). Both pH and voltage profiles show that the water-splitting reaction, considered the major parasitic side-reaction, did not occur in the redox ED when the system was operated below 30 mA (FIGS. 5A and 5B). Besides, the conductivity profiles show that redox ED was capable of 48% greater salt removal on average than conventional ED (FIG. 5B), revealing the exceptional charge efficiency of the redox ED (average charge efficiency of 93%).

For succinic acid recovery, 16% more succinate was up-concentrated via the redox ED system than the conventional ED without any succinate crossing over the functionalized membrane (FIG. 5C). The voltage profile of redox ED was a plateau, featuring the continuous reversible redox reaction between the ferri- and ferrocyanide. Also, the redox ED system reduced 52% of the energy consumption of the conventional ED system (0.73 kWh/m³) (FIG. 5D). In the case of conventional ED, 8% of total succinate was detected in the redox channel, and thus, the succinate flux and the final enriched concentration were lower than in the redox-ED system (FIGS. 5C and 5D).

The stability of the functionalized membrane was evaluated under various solution conditions ((i) DI, (ii) acid of pH 3.5, (iii) base of pH 10.5, (iv) 100 mM ferrocyanide, (v) 100 mM hydroxyl radical, and (vi) 100 mM chlorine), which occur in either the redox ED or ED systems and possibly damage the functional groups on the membrane. There were no significant changes observed in the polyelectrolyte layers from the FTIR spectra and SEM images after an hour-long immersion of LBL10 in most conditions, including (ii) acid, (iii) base, and (iv) ferrocyanide (FIG. 5E). However, when the functionalized membrane was exposed to chlorine (vi), the absorption bands for PEI and PSS at 1190, 1128, 1040, and 1009 cm⁻¹ were no longer detectable (red-FTIR spectra in FIG. 5E). SEM also confirmed that the polyelectrolyte layers on the modified membrane were washed out after the chlorine exposure (FIG. 5F). The results demonstrated that the functionalized membrane may be unstable under the chlorine generation condition, as chlorine and strong oxidizers likely cause degradation of the functional groups on the membrane and the chain scission of the polymer backbone. When chloride is oxidized on the anode, it generates hypochlorous acid (HClO) in the presence of water. Then the generated HClO can cause the degradation of the polyelectrolyte layers and even break the polymer backbone chain. Chlorine generation (E⁰=1.36 V vs NHE) is often considered a competing reaction of the oxygen evolution reaction (E⁰=1.23 V vs NHE) on the anode. In particular, since the fermentation downstream solution consists of chloride as a major inorganic impurity, operating the electrochemical system at a voltage below the water-splitting reaction helps to avoid the degradation of the functionalized membrane. In this regard, integrating the functionalized membrane with the redox-mediated system described in this disclosure can prolong the stability of functional groups while maintaining high selectivity toward organic acids. Consequently, succinate was enriched in the accumulating channel with a flux rate of 0.062 mol/m²/h, without any noticeable succinate loss in the redox channel, or membrane degradation (see green-FTIR spectra in FIG. 5E). Overall, redox-mediated ED may be advantageous for the organic recovery process not only by lowering energy consumption but also by enhancing the stability of the functionalized membrane.

Organic Acid Recovery from a Synthetic Fermentation Downstream Solution

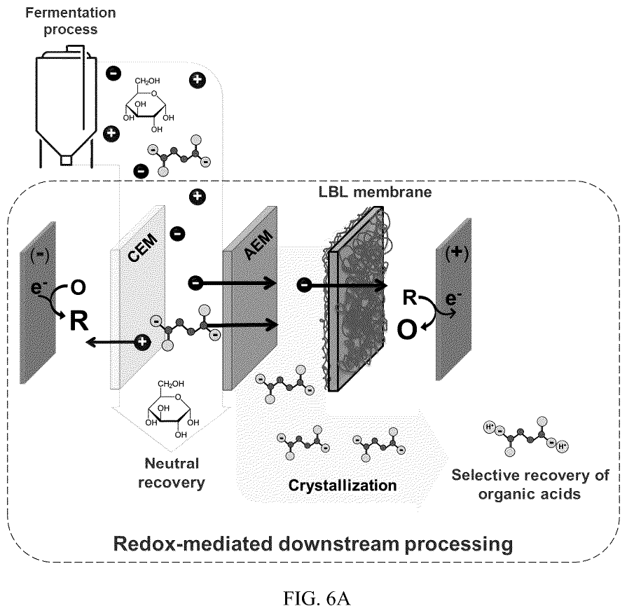

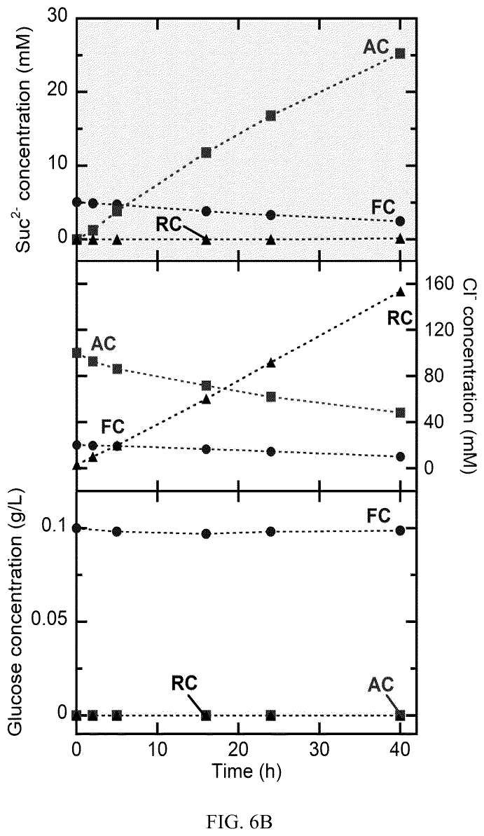

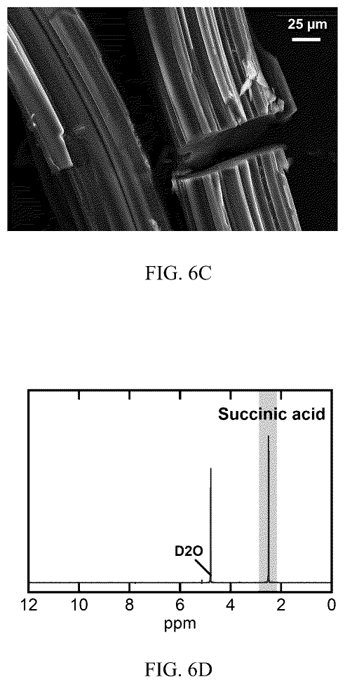

For proof-of-concept, succinic acid recovery was demonstrated from a synthetic fermentation downstream solution at the lab-scale. The synthetic fermentation waste consisted of 0.1 g/L glucose, 20 mM NaCl, and 5 mM Na₂Suc, which is representative of residual carbohydrates, inorganic salts, and organic acid products in complex fermentation broths. Using a redox-mediated electrochemical system, the succinate was up-concentrated after 40-hours-operation of the redox-ED system, and then the enriched succinate was passed to a crystallization process to produce pure succinic acid crystals (FIG. 6A). Over 40 hours of operation, the succinate was linearly enriched in the accumulating channel by a factor of 5, while a linear decrease of the succinate was observed in the feed channel (FIG. 6B). In the redox channel, a substantial amount of chloride was accumulated (160 mM) without any succinate cross-over through the functionalized membrane. Moreover, the system enabled the persistent recovery of neutral species in the feed channel (FIG. 6B).

The successful recovery of organic acid from complex synthetic fermentation solutions provides a proof-of-concept of the use of selective membranes for process intensification in biomanufacturing. By tailoring the membranes and arranging them rationally in a multi-channel redox-ED system, each channel can be tuned to enrich/recover different types of species from a complex solution. For instance, the feed channel can recover the residual carbohydrates which might be recycled back into the fermentation process, whereas the enriched organic acids can be processed into pure product form by crystallization. To demonstrate this capability, rod-shaped succinic acid crystals were produced from the enriched solution (FIG. 6C). Both EDS and NMR confirmed that organic acid crystals were synthesized with a high purity of 99.7% (FIG. 6D). Prior to the crystallization, conventional succinic acid production undergoes sequential separation processes for separating organic acids from existing neutral and ionic species (e.g., coupling with filtration and ion-exchange column); thus, the major challenge of conventional separation processes is considerably low yield and purity of the final product, as well as the demanding energy and chemical uses. On the other hand, our electrochemical separation can reduce the number of separation steps (e.g., a series of filtration steps for separating organic acids from large carbohydrates and inorganic species), possibly offering a new avenue to enhance productivity, reduce overall carbon footprint and even production cost.

The system and method described in this disclosure offers a facile and generalizable pathway for selective membrane design. By integrating layer-by-layer functionalized membranes with the redox-electrodialysis system, molecular selectivity enhancement and the feasibility of organic acid recovery have been demonstrated. An adaptive configuration is contemplated in which a series of functionalized membranes with different functional groups, hydrophilicity, and/or polyelectrolyte layers can be arranged to partition among multiple structurally close, identically charged organic species. Thus, the redox-ED system coupled with the functionalized membrane can be a stepping stone toward modular multicomponent separations by sequential membranes, for a range of ion-selective applications in biochemical and chemical industries.

To summarize, highly selective organic acid recovery from an inorganic species can be achieved by controlling membrane surface hydrophilicity, electrostatic repulsion, and steric hindrance with the polyelectrolyte layers. The combination of an extensive membrane characterization and experimental investigation highlights that the selectivity of the functionalized membrane may be attributed to the hydrophilicity of the membrane surface, electrostatic repulsion, and steric hindrance, while the ion mobility of the AEM seems to be determined mainly by the species charge, followed by the size of the hydrated molecules. The change in multicomponent flux (e.g., succinate with various inorganic anions) with various polyelectrolyte layers underlines a wide range of tunability for ionic organic species retention (up to 100%) while preserving the total flux of inorganic ions. This remarkable ionic organic species retention may be translated to mono- and multivalent organic acids with the enrichment flux up to 0.071 mol/m²/h and continuous depletion of inorganic ions with the depletion flux down to −0.13 mol/m²/h. Furthermore, the sequential arrangement of the AEM and functionalized membrane in the redox-mediated ED system can lead to continuous ionic organic species (e.g., succinate) enrichment and the production of at least 99.7% pure organic acid (e.g., succinic acid) crystals from a synthetic fermentation solution, in tandem with the partitioning of the neutral, inorganic ions, and organic acids in a single-stage, possibly valorizing neutral species (e.g., residual carbohydrates) and inorganic salts along with the organic acid products. In addition, by leveraging a reversible redox reaction far below the water-splitting reaction, the system can eliminate the propensity of membrane degradation caused by chlorination. This technology enables the possible partition of organic anions from neutral and charged inorganic anions without a sequential separation process or regeneration step. Overall, the combination of facile functionalized membrane and redox-mediated electrochemical separations has been shown to be applicable to the process-intensified multicomponent separation of valuable molecules for downstream processing in biomanufacturing.

To clarify the use of and to hereby provide notice to the public, the phrases “at least one of <A>, <B>, . . . and <N>” or “at least one of <A>, <B>, . . . or <N>” or “at least one of <A>, <B>, . . . <N>, or combinations thereof” or “<A>, <B>, . . . and/or <N>” are defined by the Applicant in the broadest sense, superseding any other implied definitions hereinbefore or hereinafter unless expressly asserted by the Applicant to the contrary, to mean one or more elements selected from the group comprising A, B, . . . and N. In other words, the phrases mean any combination of one or more of the elements A, B, . . . or N including any one element alone or the one element in combination with one or more of the other elements which may also include, in combination, additional elements not listed. Unless otherwise indicated or the context suggests otherwise, as used herein, “a” or “an” means “at least one” or “one or more.”

While various embodiments have been described, it will be apparent to those of ordinary skill in the art that many more embodiments and implementations are possible. Accordingly, the embodiments described herein are examples, not the only possible embodiments and implementations.

In addition to the features mentioned in each of the independent aspects enumerated above, some examples may show, alone or in combination, the optional features mentioned in the dependent aspects and/or as disclosed in the description above and shown in the figures.

1. A system for recovering organic acid products from a multicomponent feed solution, the system comprising:
a first electrode;
a second electrode positioned in opposition to the first electrode;
a cation exchange membrane and an anion exchange membrane disposed between the first and second electrodes, thereby defining a feed channel extending between the cation and anion exchange membranes for delivery of a multicomponent feed solution including an organic acid and an inorganic salt;
a functionalized membrane disposed between the cation or anion exchange membrane and the first or second electrode, thereby defining an accumulating channel extending between the cation or anion exchange membrane and the functionalized membrane for collecting charged organic species separated from the multicomponent feed solution; and
a redox channel containing the first and second electrodes and being separated from the feed and accumulating channels by the cation or anion exchange membrane and the functionalized membrane.

2. The system of claim 1, wherein the functionalized membrane comprises:
a membrane backbone; and
one or more polyelectrolyte layers coated on the membrane backbone,
wherein the membrane backbone is selected from the group consisting of:
anion exchange membrane backbone, cation exchange membrane backbone, nanofiltration membrane backbone, and cellulose-based membrane backbone.

3. The system of claim 1, wherein the functionalized membrane is disposed between the anion exchange membrane and the second electrode, the accumulating channel thereby extending between the anion exchange membrane and the functionalized membrane,
wherein the redox channel is separated from the feed and the accumulating channels by the cation exchange membrane and the functionalized membrane,
wherein the second electrode is configured to become positively charged upon application of a voltage, and
wherein the accumulating channel is configured for collection of anionic organic species separated from the multicomponent feed solution.

4. The system of claim 3, wherein the functionalized membrane includes only one polyelectrolyte layer on the membrane backbone, and
wherein the only one polyelectrolyte layer comprises a polyanion layer.

5. The system of claim 3, wherein the one or more polyelectrolyte layers include polyanion layers and polycation layers in an alternating arrangement.

6. The system of claim 1, wherein the functionalized membrane is disposed between the cation exchange membrane and the second electrode, the accumulating channel thereby extending between the cation exchange membrane and the functionalized membrane,
wherein the redox channel is separated from the feed and the accumulating channels by the anion exchange membrane and the functionalized membrane,
wherein the second electrode is configured to become negatively charged upon application of a voltage, and
wherein the accumulating channel is configured for collection of cationic organic species from the multicomponent feed solution.

7. The system of claim 6, wherein the functionalized membrane includes only one polyelectrolyte layer on the membrane backbone, and wherein the only one polyelectrolyte layer comprises a polycation layer.

8. The system of claim 6, wherein the one or more polyelectrolyte layers include polyanion layers and polycation layers in an alternating arrangement.

9. A method of recovering organic acid products from a multicomponent feed solution, the method comprising:
providing a system comprising:
a first electrode;
a second electrode positioned in opposition to the first electrode;
a cation exchange membrane and an anion exchange membrane disposed between the first and second electrodes, thereby defining a feed channel extending between the cation and anion exchange membranes;
a functionalized membrane disposed between the anion exchange membrane and the second electrode, thereby defining an accumulating channel extending between the anion exchange membrane and the functionalized membrane; and
a redox channel containing the first and second electrodes and being separated from the feed and accumulating channels by the cation exchange membrane and the functionalized membrane,
flowing a redox solution comprising a redox couple through the redox channel;
flowing a multicomponent feed solution including an organic acid and an inorganic salt through the feed channel, the organic acid and the inorganic salt comprising ionic species;
applying a voltage, the first electrode becoming negatively charged and the second electrode becoming positively charged, the redox couple undergoing reduction near the first electrode and oxidation near the second electrode;
whereby anionic species from the multicomponent feed solution are drawn through the anion exchange membrane into the accumulating channel, the anionic species including anionic organic species and anionic inorganic species, cationic species are drawn through the cation exchange membrane, and neutral species remain in the feed channel,
wherein, after being drawn through the anion exchange membrane, the anionic organic and inorganic species are separated, the anionic inorganic species being drawn through the functionalized membrane and the anionic organic species remaining and accumulating in the accumulating channel.

10. The method of claim 9, wherein the multicomponent feed solution comprises a fermentation solution from food, pharmaceutical, chemical, or industrial manufacturing.

11. The method of claim 9, wherein the organic acid includes succinic acid, pyruvic acid, lactic acid, and/or citric acid, and
wherein the anionic organic species includes succinate, pyruvate, lactate, and/or citrate.

12. The method of claim 9, wherein, at an operating current of 10 mA or a current density of about 1 mA/cm², the anionic organic species is enriched in the accumulating channel at a flux rate of at least about 0.05 mol/m²/h.

13. The method of claim 9, wherein, at an operating current of 10 mA or a current density of about 1 mA/cm², the anionic inorganic species is depleted from the accumulating channel at a flux rate at or below −0.06 mol/m²/h.

14. The method of claim 9, wherein, after enrichment in the accumulating channel, the anionic organic species undergoes a crystallization process to produce purified organic acid crystals.

15. A method of recovering organic acid products from a multicomponent feed solution, the method comprising:
providing a system comprising:
a first electrode;
a second electrode positioned in opposition to the first electrode;
a cation exchange membrane and an anion exchange membrane disposed between the first and second electrodes, thereby defining a feed channel extending between the cation and anion exchange membranes;
a functionalized membrane disposed between the cation exchange membrane and the second electrode, thereby defining an accumulating channel extending between the cation exchange membrane and the functionalized membrane; and
a redox channel containing the first and second electrodes and being separated from the feed and accumulating channels by the anion exchange membrane and the functionalized membrane,
flowing a redox solution comprising a redox couple through the redox channel;
flowing a multicomponent feed solution including organic acid and an inorganic salt through the feed channel, the organic acid and the inorganic salt comprising ionic species;
applying a voltage, the first electrode becoming positively charged and the second electrode becoming negatively charged, the redox couple undergoing oxidation near the first electrode and reduction near the second electrode,
whereby cationic species from the multicomponent feed solution are drawn through the cation exchange membrane into the accumulating channel, the cationic species including cationic organic species and cationic inorganic species, anionic species are drawn through the anion exchange membrane, and neutral species remain in the feed channel,
wherein, after being drawn through the cation exchange membrane, the cationic organic and inorganic species are separated, the cationic inorganic species being drawn through the functionalized membrane and the cationic organic species remaining and accumulating in the accumulating channel.

16. The method of claim 15, wherein the multicomponent feed solution comprises a fermentation solution from food, pharmaceutical, chemical, or industrial manufacturing.

17. The method of claim 15, wherein the organic acid includes amino acid, and
wherein the cationic organic species includes tryptophan ethyl ester, arginine ethyl ester, and/or histidine ethyl ester.

18. The method of any claim 15, wherein, at an operating current of 10 mA or a current density of about 1 mA/cm², the cationic organic species is enriched in the accumulating channel at a flux rate of at least about 0.05 mol/m²/h.

19. The method of any claim 15, wherein, at an operating current of 10 mA or a current density of about 1 mA/cm², the cationic inorganic species is depleted from the accumulating channel at a flux rate at or below −0.06 mol/m²/h.

20. The method of claim 15, wherein, after enrichment in the accumulating channel, the cationic organic species undergoes a crystallization process to produce purified organic acid crystals.
